(19) United States
(12) Patent Application Publication
(10) Pub. No.: US 2022/0275279 A1
(43) Pub. Date: Sep. 1, 2022

(54) PREPARATION METHOD AND APPLICATION OF REACTIVE POLYURETHANE FLAME RETARDANT

(71) Applicant: SHANDONG UNIVERSITY OF TECHNOLOGY, Zibo (CN)

(72) Inventors: Zhongfang LI, Zibo (CN); Peng SUN, Zibo (CN); Hui GUO, Zibo (CN); Likai WANG, Zibo (CN); Xueliang NIU, Zibo (CN)

(73) Assignee: SHANDONG UNIVERSITY OF TECHNOLOGY, Zibo (CN)

(21) Appl. No.: 17/631,502

(22) PCT Filed: Dec. 16, 2020
(86) PCT No.: PCT/CN2020/136806

§ 371 Date: Jan. 31, 2022

(30) Foreign Application Priority Data
Feb. 7, 2020 (CN) 202010082370.X

(51) Int. Cl. C09K 21/14; C09K 21/04; C08L 75/08; C08J 9/00; C08J 9/12; C08J 9/10; C08J 9/08

(52) U.S. Cl. CPC C09K 21/14; C09K 21/04; C08L 75/08; C08J 9/0061; C08J 9/125; C08J 9/10; C08J 9/08; C08L 2201/02; C08L 2203/14; C08L 2312/00; C08J 2203/10; C08J 2203/02; C08J 2203/04; C08J 2375/08; C08J 2385/02

(57) ABSTRACT

The polyurethane flame retardant is prepared by compounding poly(diphosphophosphazene) (PDPP) and derivatives thereof, poly(diphosphate phosphazene) (MPDPP) (where M=Mg²⁺, Ca²⁺, transition metal ions, rare earth ions and the like) and poly(diphosphonic phosphazene). Since a phosphate group in the PDPP and an unreacted phosphate group in the MPDPP in the compound and an unreacted hydroxyl in the phosphate group may react with isocyanate, the flame retardant is a reactive flame retardant. Due to the reaction between the flame retardant and the isocyanate, the flame retardant is uniformly distributed in polyurethane and has a better flame-retardant effect. The flame retardant contains multiple flame-retardant components, namely polyphosphazene group, phosphate ester and phosphate salt. Due to the synergistic effect, the flame retardant has good flame-retardant properties, and can be used for various polyurethane materials.

### CROSS REFERENCE TO THE RELATED APPLICATIONS

This application is the national phase entry of International Application No. PCT/CN2020/136806, filed on Dec. 16, 2020, which is based upon and claims priority to Chinese Patent Application No. 202010082370.X, filed on Feb. 7, 2020, the entire contents of which are incorporated herein by reference.

### TECHNICAL FIELD

The invention provides a reactive flame retardant which can be used in the fields of polyurethane, textiles, wood, paper, decorative materials, and the like.

### BACKGROUND

Flame retardants are functional additives that make flammable polymers flame-retardant and are mainly designed for flame retarding of polymer materials. There are many types of flame retardants, which can be divided into additive flame retardants and reactive flame retardants according to the use methods. Additive flame retardants are added to a polymer by mechanical mixing to make the polymer have flame-retardant properties. At present, additive flame retardants are mainly classified into organic flame retardants and inorganic flame retardants, and halogen flame retardants (organochlorides, organobromides) and non-halogen flame retardants. Organic flame retardants are flame retardants based on bromine, phosphorus and nitrogen, red phosphorus compounds, and the like, and inorganic flame retardants use antimony trioxide, magnesium hydroxide, aluminum hydroxide, silicon, and the like as flame-retardant systems. Reactive flame retardants are used as a reactant to participate in polymerization, so that the polymer itself has certain flame-retardant components. The reactive flame retardants have the advantages of less influence on performance of polymer materials and longer flame-retardation time.

There are many mechanisms by which flame retardants play a role in flame retardation, and most flame retardants are flame retardants by the synergistic action of several mechanisms. (1) Endothermic effect: The combustion reaction releases a limited amount of heat within a certain period. The flame retardant can absorb part of the heat released by the reaction in time to reduce the temperature and reduce the heat absorbed by the combustion surface and combustible molecules, thereby inhibiting the progress of combustion. Under high-temperature reaction conditions, the flame retardant can perform an endothermic effect, absorb the heat of the reaction, reduce the surface temperature of combustibles and prevent the generation of combustible gases, thereby playing the flame-retardant role. (2) Covering effect: The flame retardant can form a covering in a certain shape under high-temperature conditions, so that combustibles can be isolated from air to allow the covering to perform functions of oxygen isolation, heat insulation and gas leakage prevention, thereby playing the flame-retardant role. (3) Inhibition of chain reaction: According to chain reaction, certain free radicals are needed for combustion reaction. The flame retardant can capture the free radicals in the gas-phase combustion reaction, prevent the spread of combustion, and reduce the combustion reaction rate until the end of the combustion. (4) Quenching of non-combustible gases: The flame retardant can be decomposed to release non-combustible gases, so that the density of combustible gases is reduced and the concentration of oxygen is diluted, thereby quenching the combustion and achieving the flame-retardant objective.

Flame-retardant material is to add flame retardant into the material and remix them for flame retardant treatment. The flame-retardant material is characterized by being a protective material that increases the ignition point and reduces the combustion speed, thereby preventing combustion and making itself uninflammable. Flame retardant materials are widely used, can be made into various industrial products, and can be mainly divided into 7 categories, flame-retardant fabrics, flame-retardant chemical fibers, flame-retardant plastics, flame-retardant rubber, fire-retardant coatings, flame-retardant wood materials and flame-retardant paper, and inorganic non-combustible filling materials.

The development of flame-retardant science and technology is to meet the needs of social safety production and life, and is of great significance for preventing fires and protecting lives and properties of people. The research of flame-retardant science and technology mainly includes the study of flame-retardation mechanisms, the preparation process of flame retardant, selection of flame-retardant system, development of flame-retardant treatment and products thereof, and evaluation of flame-retardant treatment technology and flame-retardant effect. At the same time, to meet the social demand for flame-retardant materials and the necessity of popularization, it is also necessary to study and formulate relevant technical standards, specifications and management regulations, and carry out a large number of application researches on flame-retardant material products. Nowadays, it is gradually recognized that the rational use of certain flame-retardant materials is one of the strategic measures to reduce fires, and flame retardation, smoke suppression and toxicity reduction can be achieved at the same time. Therefore, the research on flame retardants becomes particularly important. Flame-retardant materials are not only required to have a good flame-retardant effect, but also not to generate toxic or unusual combustion products. In this way, it is entirely possible to prevent the occurrence of combustion through a rational and safe fire protection design and the use of flame-retardant products, which is also of great significance for promoting the development of fire safety design.

C. H. Powell Jr. et al. reported (CN 201280013371.2) brominated diester diol aromatic compound as a reactive flame retardant for flexible polyurethane foam. This flame retardant belongs to a halogen-containing reactive flame retardant, and the reactive group is hydroxyl. Fan Haojun et al. reported (CN 201410704651.9) phosphate-substituted diamino-1,3,5-triazine derivativesas a reactive intumescent flame retardant for water-based polyurethane. K. Rhudy et al. reported (CN201480045154.0) phosphorous-containing alcohol components as a reactive flame retardant. ShouChongqi et al. reported (CN 201610804469.X) a preparation method of a hyperbranched flame retardant and application of the hyperbranched flame retardant in polyurethane. For example, a phosphorus-containing hyperbranched flame retardant can be applied by substituting hydroxyl in a hydroxyl-terminated hyperbranched polymer with a phosphorus-containing group. S. Bourbigot et al. (CN 201280011035.4) reported a reactive flame retardant for polyurethane flame retardant, which contained a phosphate component of salts formed by melamine and phosphoric acid and mixtures thereof. In this flame retardant, inorganic phosphoric acid and the amino group of melamine respectively serve as active groups of the reactive flame retardant. However, the phosphoric acid and melamine respectively react with isocyanate, and they are isolated and cannot play a synergistic effect after the reaction. These solid particles have bad influence on the polymer, especially on the properties of the polyurethane foam.

According to GB/T 2406-1993 and GB/T 2408-2008 respectively, samples were prepared, and tested for flame-retardant properties such as limiting oxygen index and vertical flame test, and according to QB/T 4197-2011, samples were prepared and tested for mechanical properties such as tensile strength and elongation at break.

### SUMMARY

According to the invention, thestrong polar P—Cl bondsin poly(dichlorophosphazene) polymer is utilized to react with triphosphite to obtain poly(diphosphate phosphazene), the poly(diphosphate phosphazene) is hydrolyzed in concentrated hydrochloric acid to obtain poly(diphosphonicphosphazene), and the poly(diphosphonicphosphazene) reacts with water-soluble high-valent transition metal ions to obtain insoluble metalpoly(diphosphonicphosphazene) polymer. The specific operation steps and reaction process are as follows:

(1) Preparation of Components of Flame Retardant

Under the protection of nitrogen, hexachlorocyclotriphosphazene (HCCP) (14.4 mmol, 5 g), sulfamic acid (0.52 mmol, 0.05 g) and a solvent diphenyl ether (15-30 mL) are respectively added into a three-necked flask equipped with a stirrer and a condenser. After introducing nitrogen for 20-40 min, the mixture is stirred and heated to 210-250° C. to carry out a ring-opening polymerization reaction. When the solution becomes viscous, heating is stopped, the mixture is cooled and poured into a beaker containing 40-60 mL of petroleum ether to remove the unreacted raw material HCCP, the mixture is washed with petroleum ether three times, the obtained solid product is dried in a vacuum drying oven at 70-90° C. for 4-8 h to obtain poly(dichlorophosphazene) (PDCP). The obtained poly(dichlorophosphazene) is reacted with excess (50-60 mL) triethylphosphite at 100-120° C. for 5-7 h, the reaction mixture is cooled and washed with an appropriate amount of petroleum ether 3-4 times to remove excess unreacted triethylphosphite, suction filtration is carried out, and the solid is dried in a vacuum drying oven at 60-100° C. to obtain poly(diphosphate phosphazene) (PBPP). The obtained PBPP is added to 60-90 mL of concentrated hydrochloric acid and is hydrolyzed under stirring at 110-150° C. until the solution becomes clear. The solution is concentrated to near dryness at 110-140° C. to remove the reaction products and excess concentrated hydrochloric acid. The mixture is extracted with 30-50 mL of ethyl acetate 3-4 times to remove the incompletely hydrolyzed PBPP. The remaining liquid is dried in a vacuum drying oven at 110-130° C. to obtain poly(diphosphonicphosphazene) (PDPP). The equations of the reaction process are as follows.

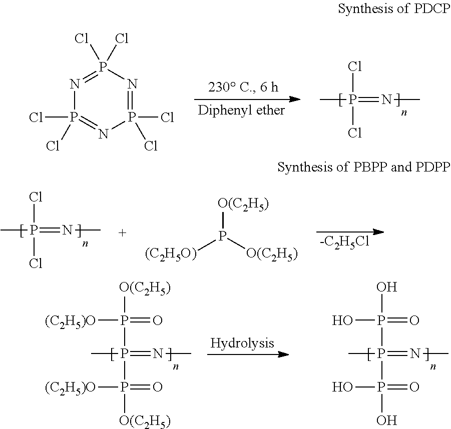

2.07 g of the obtained PDPP white solid is dissolved in a certain amount of deionized water, and 1.61 g of zirconium oxychloride is dissolved in water. After the two are respectively dissolved completely, the zirconium oxychloride solution is added dropwise to the PDPP aqueous solution while stirring. After the completion of the dropwise addition, the mixture is stirred for 24 h and subjected to suction nitration. The solid is washed with water until the washing solution is neutral, and dried in a vacuum drying oven at 80-90° C. to obtain 1.93 g of white solid ZrPDPP (0.78) (the mass ratio is zirconium oxychloride:PDPP=0.78). The yield is 76.44%. According to the method, ZrPDPP with different proportions can be obtained.

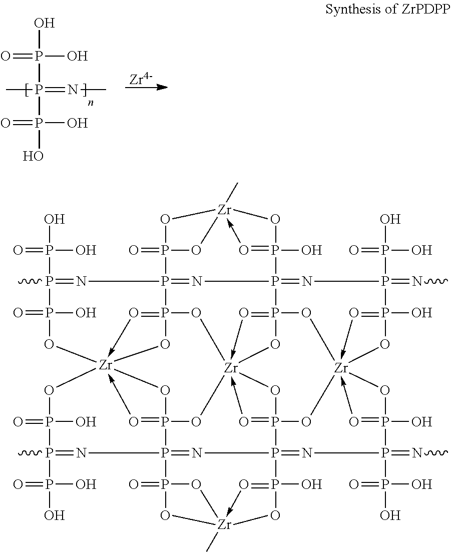

Preparation methods of salts of metals such as MgPDPP, CaPDPP and the like with different proportions are the same as above, only except that soluble salts of other metals are used instead of zirconium oxychloride.

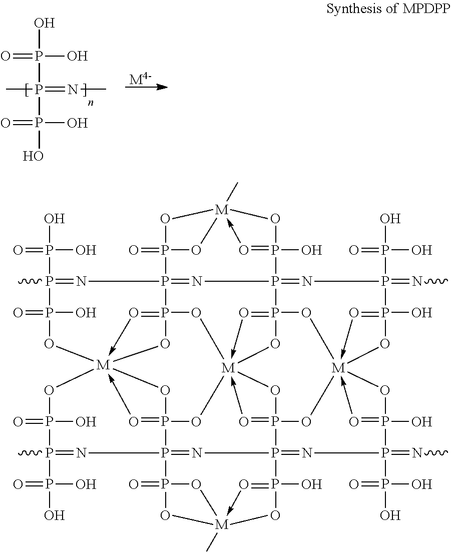

M in the above reaction equation refers to metal ions with +4, +2, or +3 valence.

(2) Research of Compounding Process of Flame Retardant

MPDPP, PDPP and PBPP are compounded in a certain ratio to obtain the reactive polyurethane flame retardant. PBPP, PDPP and MPDPP are compounded in a mass ratio of 6:1:1-1:3:4. The compounding process includes: firstly grinding the MPDPP for 1-2 h, then adding the PDPP according to the ratio and continuing grinding for 0.5-2 h, and after the mixture is ground uniformly, adding the PBPP and solvent and grinding the mixture for 0.5-2 h.

(3) Reaction of Compounded Flame Retardant with Isocyanate

(a) Reaction of PDPP with isocyanate

In the process of preparing polyurethane by mixing raw materials A and B of polyurethane, a phosphate group in the PDPP may react with isocyanate to obtain the polyurethane with the participation of polyphosphazenephosphate. The flame retardant component may be thoroughly mixed with the polyurethane and exist in the polyurethane to effectively prevent the combustion of the polyurethane, so that the best flame-retardant properties can be achieved. The reaction equation is as follows:

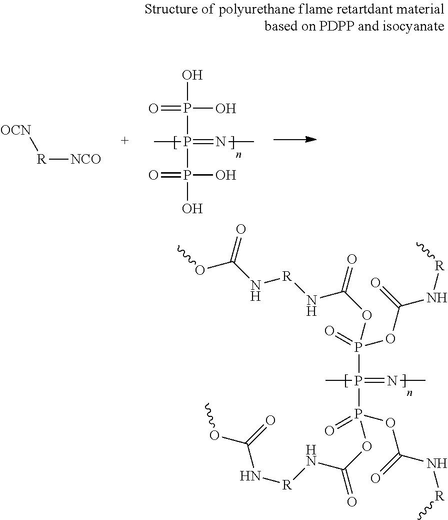

(b) Reaction of MPDPP with isocyanate

In the process of preparing polyurethane by mixing raw materials A and B of polyurethane, the phosphate group in the MPDPP that has not reacted with metal ions or the hydroxyl in the remaining phosphate group may react with isocyanate to obtain the polyurethane with the participation of MPDPP. The flame retardant component may be thoroughly mixed with the polyurethane and exist in the polyurethane to effectively prevent the combustion of the polyurethane, so that the best flame-retardant properties can be achieved. The reaction equation is as follows:

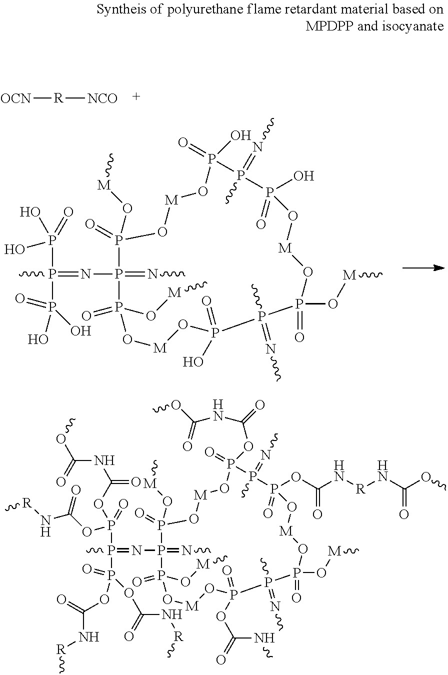

(c) The PBPP is a hydrophobic compound with good mutual solubility with polyurethane, and thus, can be directly incorporated into polyurethane to achieve the flame-retardant effect.

(4) Research of Use Method

The above flame retardant compound is added to component A of the polyurethane according to the formula and different amounts of the polyurethane. The raw materials of the polyurethane are composed of components A and B. In parts by mass, the component A (combined polyether component) includes the following ingredients: 50-100 parts of polyether polyol; 0-50 parts of polymer polyol; 0.2-5 parts of catalyst; 1-8 parts of the foaming agent; 0.2-3 parts of foam stabilizer; 0.2-6 parts of a crosslinking agent; 0-10 parts of pore former; and 0.1-20 parts of reactive flame retardant (involved in the invention). The component B (isocyanate component) is polyisocyanate, which may be TDI, MDI, polymeric MDI or modified MDI and a mixture thereof.

A mass ratio of A:B is 100:30-100:80.

The polyether glycol in the formula of the polyurethane has a functionality of 3 and a relative molecular mass of 4000-9000, and a primary hydroxyl content in the terminal hydroxyl is greater than 65%. The polymer polyol is a graft copolymer of polyether polyol and styrene acrylonitrile. The catalyst is tertiary amines or secondary amines. The foaming agent is one or a mixture of several of deionized water, polybasic primary amine and quaternary ammonium carbonate. The foam stabilizer is a polysiloxane-polyether copolymer. The crosslinking agent is an alcohol amine compound. The pore former is a polyether polyol with an EO content of ≥50%.

(5) Research of Flame-Retardant Properties of Flame Retardant

The flame retardant is added to polyurethane, and worthy products are tested for flame-retardant properties. According to GB/T 2406-1993 and GB/T 2408-2008 respectively, samples are prepared, and tested for flame-retardant properties such as limiting oxygen index and vertical flame test, and according to QB/T 4197-2011, samples are prepared and tested for mechanical properties such as tensile strength and elongation at break.

Characteristic analysis and innovations of flame retardant of the invention:

1) The flame retardant compound contains the flame-retardant inorganic polyphosphazene group and phosphate group in the molecules of each component, and has the polymeric flame-retardant component of magnesium polyphosphate and other salts.

2) The flame-retardant elements nitrogen and phosphorus in the flame retardant can produce a synergistic flame-retardant effect of nitrogen and phosphorus. Therefore, the flame retardant has better flame-retardant properties.

3) The polyphosphate group in the PBPP and the unreacted phosphate group in the MPDPP salt or the unreacted hydroxyl in the phosphate group in the components may react with isocyanate such that the flame-retardant group of the flame retardant is connected into the polyurethane, which makes the flame retardant uniformly mixed with the polyurethane and makes the flame retardation occur before the combustion. Therefore, a good flame-retardant effect can be achieved.

4) The PDPP phosphate component of the flame retardant can be mixed into the polyurethane material to achieve a flame-retardant effect.

5) The flame retardant prepared from MPDPP, PDPP and PBPP according to a certain mass ratio and the compounding technique has more flame-retardant groups and flame-retardant components, and thus, can have a better flame-retardant effect.

### DETAILED DESCRIPTION OF THE EMBODIMENTS

### EXAMPLE 1

### Preparation of poly(dichlorophosphazene)(PDCP)

Under the protection of nitrogen, hexachlorocyclotriphosphazene (HCCP) (14.4 mmol, 5 g),sulfamic acid (0.52 mmol, 0.05 g)and a solvent diphenyl ether (15-30 mL) were respectively added into a three-necked flask equipped with a stirrer and a condenser. After introducing nitrogen for 20-40 min, the mixture was stirred and heated to 210-250° C. to carry out ring-opening polymerization reaction. When the solution became viscous, heating was stopped, the mixture was cooled and poured into a beaker containing 40-60 mL of petroleum ether to remove the unreacted raw material HCCP, the mixture was washed with petroleum ether three times, suction filtration was carried out, and the obtained solid product was dried in a vacuum drying oven at 70-90° C. for 4-8 h to obtain poly(dichlorophosphazene) (PDCP). The obtained PDCP had a yield of 70% and a viscosity average molecular weight of 60000-80000.

By using the above method, the ring-opening polymerization product may also be obtained by replacing the diphenyl ether with other solvents (one or a mixture of several of aromatic solvent naphtha, sulfolane, glyceryl triacetate, pentaerythritoltetraacetate, polyethylene glycol diacetate, liquid paraffin and methylnaphthalene oil) and by controlling the temperature at 210-250° C. or at a higher reaction temperature, except that the solvent using a low-boiling-point solvent with better solubility for the solvent is used for washing during removal of the solvent.

The yield of the ring-opening polymerization reaction using different solvents was in the range of 40%-80%, and the viscosity average molecular weight was in the range of 40000-100000.

### EXAMPLE 2

### Preparation of poly(diphosphate phosphazene) (PBPP)

20 g of the obtained poly(dichlorophosphazene) was reacted with excess (50-60 mL) triethylphosphite at 100-120° C. for 5-7 h, the reaction mixture was cooled and washed with an appropriate amount of petroleum ether 3-4 times to remove excess unreacted triethylphosphite, suction filtration was carried out, and the solid was dried in a vacuum drying oven at 60-100° C. to obtain poly(diphosphate phosphazene) (PBPP). The yield of the obtained PBPP was 83%.

Using the same reaction steps, yields of reaction with different triphosphates or under different conditions are shown in Table 1.

### EXAMPLE 3

### Preparation of poly(diphosphonicphosphazene) (PDPP)

25 g of the PBPP was added to 60-90 mL of concentrated hydrochloric acid and was hydrolyzed under stirring at 110-150° C. until the solution became clear. The solution was concentrated to near dryness at 110-140° C. to remove the reaction products and excess concentrated hydrochloric acid. The mixture was extracted with 30-50 mL of ethyl acetate 3-4 times to remove the incompletely hydrolyzed PBPP. The remaining liquid was dried in a vacuum drying oven at 110-130° C. to obtain poly(diphosphonicphosphazene) (PDPP). The yield was 89%.

Using the same reaction steps, when the extraction was carried out with dichloromethane, benzene, toluene or petroleum ether, the yields were respectively 87%, 83%, 81% and 85%.

Using the same reaction steps, when reflux was carried out in concentrated hydrochloric acid for 24 h, reduced pressure distillation was carried out at 70° C. and the extraction was carried out with ethyl acetate, the yield was 84%.

Results of hydrolysis reaction of PBPP with different ester groups are shown in Table 2.

TABLE 1
Reaction conditions and yields of PBPP prepared
by reaction with different triphosphites

| Triphosphite | Charging Time | Temperature | Reaction Time | Yield |
|---|---|---|---|---|
| Trimethyl ester | 1 h | 90° C. | 5 h | 87% |
| Tripropyl ester | 0.5 h | 100° C. | 6 h | 82% |
| Triethyl ester | 0.5 h | 110° C. | 4 h | 89% |
| Triphenyl ester | 1 h | 100° C. | 10 h | 73% |
| Triisopropyl ester | 2 h | 110° C. | 6 h | 86% |
| Trimethyl ester | 1 h | 100° C. | 9 h | 92% |
| Trimethyl ester | 0.5 h | 120° C. | 4 h | 85% |

TABLE 2
Yields of PDPP prepared by hydrolyzing
PBPP with different ester groups

| Ester group of PBPP | Hydrolysis Time | Temperature | Yield of PDPP |
|---|---|---|---|
| Trimethyl ester | 24 h | 90° C. | 91% |
| Triethyl ester | 16 h | 85° C. | 76% |
| Tripropyl ester | 24 h | 110° C. | 88% |
| Triisopropyl ester | 10 h | 120° C. | 85% |
| Triethyl ester | 20 h | 95° C. | 87% |
| Trimethyl ester | 36 h | 98° C. | 91% |

### EXAMPLE 4

### Preparation of metal poly(diphosphonicphosphazene) Salt

2.07 g of the obtained poly(diphosphonicphosphazene) (PDPP) white solid was dissolved in a certain amount of deionized water, and 1.61 g of zirconium oxychloride was dissolved in dilute hydrochloric acid. After the two were respectively dissolved completely, the zirconium oxychloride solution was added dropwise to the PDPP aqueous solution while stirring. After the completion of the dropwise addition, the mixture was stirred at room temperature for 24 h and subjected to suction filtration. The solid was washed with water to neutrality, and dried in a vacuum drying oven at 80-90° C. to obtain 1.93 g of white solid ZrPDPP (0.78). The yield was 76.44%.

The metal poly(diphosphonicphosphazene) salt (MPDPP) was prepared by using the same method for preparing ZrPDPP above, only except that the zirconium salt solution was replaced with a solution of salt soluble of other metals. MPDPP with different mass proportions can be obtained by controlling the ratio of PDPP to metal salt. The preparation process and property results of products are shown in Table 3.

TABLE 3
Preparation process conditions of MPDPP compounds

| | Mass Ratio of Metal | | |
|---|---|---|---|
| Type of Metal Ion | Salt to PDPP | Product Color | Yield |
| Mg²⁺ | 0.78 | White | 75% |
| Mg²⁺ | 0.85 | White | 80% |
| Ca²⁺ | 0.78 | White | 76% |
| Zr⁴⁺ | 0.45 | White | 36% |
| Zr⁴⁺ | 0.78 | White | 76% |
| Zr⁴⁺ | 0.85 | White | 84% |
| Zr⁴⁺ | 0.92 | White | 93% |
| Ce⁴⁺ | 0.79 | Yellow | 72% |
| Ce⁴⁺ | 0.50 | Yellow | 56% |
| Ce⁴⁺ | 0.85 | Yellow | 86% |
| Fe³⁺ | 0.78 | White | 75% |
| La³⁺ | 1.41 | White | 94% |
| Y³⁺ | 0.78 | White | 87% |

### EXAMPLE 5

### Compounding Process of Flame Retardant

MPDPP, PDPP and PBPP were compounded in a certain ratio to obtain the reactive polyurethane flame retardant. PBPP, PDPP and MPDPP were compounded in a mass ratio of 6:1:1-1:3:4. The compounding process included: firstly grinding the MPDPP for 1-2 h, then adding the PDPP according to the ratio and continuing grinding for 0.5-2 h, and after the mixture was ground uniformly, adding the polyPBPP and a suitable solvent and grinding the mixture for 0.5-2 h.

### EXAMPLE 6

### Use Method of Flame Retardant in Polyurethane and Preparation Process of Polyurethane Product

The flame retardant in Example 5 was added to the already prepared formula A of polyurethane according to the ratio. The raw materials of the polyurethane were composed of components A and B. In parts by mass, the component A (combined polyether component) included the following ingredients: 50-100 parts of polyether polyol; 0-50 parts of polymer polyol; 0.2-5 parts of catalyst; 1-8 parts of a foaming agent; 0.2-3 parts of foam stabilizer; 0.2-6 parts of a crosslinking agent; 0-10 parts of pore former; and 0.1-20 parts of reactive flame retardant (involved in the invention). The component B (isocyanate component) was polyisocyanate, which may be TDI, MDI, polymeric MDI or modified MDI and a mixture thereof. A mass ratio of A:B was 100:30-100:80.

The polyether glycol in the formula of the polyurethane had a functionality of 3 and a relative molecular mass of 4000-9000, and a primary hydroxyl content in the terminal hydroxyl was greater than 65%. The polymer polyol was a graft copolymer of polyether polyol and styrene acrylonitrile. The catalyst was tertiary amines or secondary amines. The foaming agent was one or a mixture of several of deionized water, polybasic primary amine and quaternary ammonium carbonate. The foam stabilizer was a polysiloxane-polyether copolymer. The crosslinking agent was an alcohol amine compound. The pore former was a polyether polyol with an EO content of ≥50%.

For the prepared polyurethane products with the flame retardant added, according to GB/T 2406-1993 and GB/T 2408-2008 respectively, samples were prepared, and tested for flame-retardant properties such as limiting oxygen index and vertical flame test, and according to QB/T 4197-2011, samples were prepared and tested for mechanical properties such as tensile strength and elongation at break. The results are shown in Table 4.

TABLE 4
Flame-retardant properties of polyurethane using
PBPP, PDPP and MPDPP compounded flame retardants

| | Added | Limiting | Fire |
|---|---|---|---|
| Mass Ratio of Compounding | Amount | Oxygen Index | Rating |
| PBPP:PDPP:MPDPP | (%) | (LOI) | (UL-94) |
| EtPBPP:PDPP:MgPDPP | 6% | 44 | Non- |
| MePBPP:PDPP:MgPDP | 10% | 48 | Non- |
| EtPBPP:PDPP:CaPDPP | 6% | 48 | Non- |
| MePBPP:PDPP:CaPDPP | 10% | 48 | Non- |
| EtPBPP:PDPP:ZrPDPP | 5% | 39 | V-0 |
| MePBPP:PDPP:ZrPDPP | 5% | 42 | Non- |
| PrPBPP:PDPP:ZrPDPP | 6% | 43 | Non- |
| EtPBPP:PDPP:CePDPP | 9% | 44 | Non- |
| EtPBPP:PDPP:CePDPP | 10% | 41 | Non- |
| MePBPP:PDPP:CePDPP | 8% | 42 | Non- |
| PrPBPP:PDPP:CePDPP | 5% | 38 | V-0 |
| EtPBPP:PDPP:FePDPP | 7% | 42 | Non- |
| MePBPP:PDPP:FePDPP | 10% | 45 | Non- |
| PrPBPP:PDPP:FePDPP | 10% | 46 | Non- |
| EtPBPP:PDPP:LaPDPP | 6% | 39 | Non- |
| MePBPP:PDPP:LaPDPP | 5% | 43 | Non- |
| EtPBPP:PDPP:YPDPP | 7% | 44 | Non- |
| EtPBPP:PDPP = 1:1 | 5% | 36 | V-0 |
| ZrPDPP:PDPP = 1:1 | 5% | 38 | V-0 |
| EtPBPP:CePDPP = 1:1 | 5% | 32 | V-0 |

Note:
RTHP: esters, Me—methyl; Et—ethyl; Pr—propyl, etc.

1. A reactive polyurethane flame retardant, wherein the flame retardant is obtained by compounding poly(diphosphate phosphazene), poly(diphosphonicphosphazene) and metal poly(diphosphonicphosphazene) salt; and a mass ratio of the poly(diphosphate phosphazene) to the poly(diphosphonicphosphazene) to the metal poly(diphosphonicphosphazene) salt is 6:1:1-1:3:4.

2. A preparation method of the reactive polyurethane flame retardant according to claim 1, comprising the following steps:
grinding a metal poly(diphosphonicphosphazene) salt for 1-2 h;
adding the poly(diphosphonicphosphazene) to continue grinding for 0.5-2 h;
adding the poly(diphosphate phosphazene) and a solvent to obtain a mixture, and
grinding the mixture for 0.5-2 h.

3. The preparation method according to claim 2, wherein the poly(diphosphate phosphazene)is prepared by a method comprising the following steps:
carrying out a ring-opening polymerization with hexachlorocyclotriphosphazene as a raw material in a high-boiling-point solvent at 210-250° C. to obtain poly(dichlorophosphazene);
[[W]]wherein the high-boiling-point solvent has a boiling point of higher than 220° C. and is stable to the hexachlorocyclotriphosphazene and the poly(dichlorophosphazene); and
reacting the poly(dichlorophosphazene) with triphosphite at 100-120° C. to obtain the poly(diphosphate phosphazene).

4. The preparation method according to claim 3, wherein the poly(diphosphonicphosphazene) is prepared by a method comprising the following step:
hydrolyzing the poly(diphosphate phosphazene) in concentrated hydrochloric acid to obtain the poly(diphosphonicphosphazene).

5. The preparation method according to claim 4, wherein the metal poly(diphosphonicphosphazene) salt is prepared by a method comprising the following step:
reacting the poly(diphosphonicphosphazene) with a metal ion solution to obtain the metal poly(diphosphonicphosphazene) salt.

6. A preparation method of a reactive polyurethane flame retardant, wherein the reactive polyurethane flame retardant is a compound obtained by compounding poly(diphosphate phosphazene), poly(bis(dialkoxyphosphate)phosphazene) and poly(diphosphophosphazene); wherein in the reactive polyurethane flame retardant, since a phosphate group in the poly(diphosphophosphazene) and an unreacted phosphate group in the poly(diphosphate phosphazene) in the compound and an unreacted hydroxyl in the phosphate group react with isocyanate, the reactive polyurethane flame retardant has a reactive flame retardant effect; due to the reaction between the reactive polyurethane flame retardant and the isocyanate, the reactive polyurethane flame retardant is uniformly distributed in a polyurethane material to produce a better flame-retardant effect;
the preparation method of the reactive polyurethane flame retardant comprises the following steps:
(1) carrying out a heated ring-opening polymerization with hexachlorocyclotriphosphazene as a raw material in a high-boiling-point solvent at 210-250° C. to obtain poly(dichlorophosphazene); reacting the poly(dichlorophosphazene) with triphosphate at 100-120° C. to obtain the poly(bis(dialkoxyphosphate)phosphazene);
hydrolyzing the poly(bis(dialkoxyphosphate)phosphazene) in concentrated hydrochloric acid to obtain the poly(diphosphophosphazene); polymerizing the poly(diphosphophosphazene) with one or more of metal ions to obtain the poly(diphosphate phosphazene); and
(2) compounding the poly(diphosphate phosphazene), the poly(bis(dialkoxyphosphate)phosphazene) and the poly(diphosphophosphazene) in a certain ratio to obtain the reactive polyurethane flame retardant used for polyurethane.

7. The preparation method according to claim 3, wherein the high-boiling-point solvent is one solvent or a mixture of several solvents selected from the group consisting of aromatic solvent naphtha, diphenyl ether, sulfolane, glyceryl triacetate, pentaerythritoltetraacetate, polyethylene glycol diacetate, liquid paraffin and methylnaphthalene oil.

8. The preparation method according to claim 3, wherein the triphosphite is one phosphite or a mixture of several of phosphites selected from the group consisiting of trimethylphosphite, triethylphosphite, tripropylphosphite and triisopropylphosphite.

9. The preparation method according to claim 4, wherein a temperature of the step of hydrolyzing the poly(diphosphate phosphazene) is 110-150° C.

10. The preparation method according to claim 5, wherein a metal ion in the metal ion solution is one or more selected from the group consisting of Mg²⁺, Ca²⁺, transition metal ion or rare earth ion; and a salt of the metal ion in the metal ion solution is soluble in water and is ionizable in an aqueous solution to release the metal ion, and the salt of the metal ion is one or more selected from the group consisting of acetate, hydrochloride and nitrate.

11. The preparation method according to claim 5, wherein a mass ratio of the metal ion in the metal ion solution to the poly(diphosphophosphazene) is 2:5-3:2.

12. The preparation method according to claim 6, wherein the poly(bis(dialkoxyphosphate)phosphazene), the poly(diphosphophosphazene) and the poly(diphosphate phosphazene) are compounded in a mass ratio of 6:1:1-1:3:4; and
the compounding process comprises: firstly grinding the poly(diphosphate phosphazene) for 1-2 h, then adding the poly(diphosphophosphazene) according to the mass ratio and continuing grinding for 0.5-2 h, and adding the poly(bis(dialkoxyphosphate)phosphazene) and a solvent to obtain a mixture and grinding the mixture for 0.5-2 h.

13. A flame-retardant polyurethane, wherein raw materials of the flame-retardant polyurethane are composed of a first component and a second component,
wherein the first component contains: polyether polyol, polymer polyol, a catalyst, a foaming agent, a foam stabilizer, a crosslinking agent, a pore former and a reactive polyurethane flame retardant; wherein the reactive polyurethane flame retardant is the reactive polyurethane flame retardant according to claim 1; a number of parts by mass of the reactive polyurethane flame retardant is 0.1-20;
the second component contains polyisocyanate; wherein the polyisocyanate comprises: one or a mixture of several selected from the group consisting of toluene diisocyanate, diphenylmethanediisocyanate, polymeric diphenylmethanediisocyanate and modified diphenylmethanediisocyanatc and mixtures thereof; and
a mass ratio of the first component to the second component is 100:30-100:80.

14. The flame-retardant polyurethane according to claim 13, wherein the first component contains the following components in parts by mass: 50-100 parts of the polyether polyol; 0-50 parts of the polymer polyol; 0.2-5 parts of the catalyst; 1-8 parts of the foaming agent; 0.2-3 parts of the foam stabilizer; 0.2-6 parts of the crosslinking agent; 0-10 parts of the pore former; and 0.1-20 parts of the reactive polyurethane flame retardant.

15. The flame-retardant polyurethane according to claim 13, wherein
the polyether polyol has a functionality of 3 and a relative molecular mass of 4000-9000 Da, and a primary hydroxyl content in a terminal hydroxyl is greater than 65%;
the polymer polyol is a graft copolymer of polyether polyol and styrene acrylonitrile;
the catalyst is a tertiary amine or a secondary amine;
the foaming agent is one or a mixture of several selected from the group consisting of deionized water, polybasic primary amine and quaternary ammonium carbonate;
the foam stabilizer is a polysiloxane-polyether copolymer;
the crosslinking agent is an alcohol amine compound; and
the pore former is a polyether polyol with an EO content of ≥50%.

16. The preparation method according to claim 6, wherein the high-boiling-point solvent is one solvent or a mixture of several solvents selected from the group consisting of aromatic solvent naphtha, diphenyl ether, sulfolane, glyceryl triacetate, pentaerythritoltetraacetate, polyethylene glycol diacetate, liquid paraffin and methylnaphthalene oil.

17. The preparation method according to claim 6, wherein the triphosphite is one phosphite or a mixture of several of phosphites selected from the group consisiting of trimethylphosphite, triethylphosphite, tripropylphosphite and triisopropylphosphite.

18. The preparation method according to claim 6, wherein a temperature of the step of hydrolyzing the poly(diphosphate phosphazene) is 110-150° C.

19. The preparation method according to claim 6, wherein a metal ion in the metal ion solution is one or more selected from the group consisting of Mg²⁺, Ca²⁺, transition metal ion or rare earth ion; and a salt of the metal ion in the metal ion solution is soluble in water and is ionizable in an aqueous solution to release the metal ion, and the salt of the metal ion is one or more selected from the group consisting of acetate, hydrochloride and nitrate.

20. The preparation method according to claim 6, wherein a mass ratio of the metal ion in the metal ion solution to the poly(diphosphophosphazene) is 2:5-3:2.
